(19) United States
(12) Patent Application Publication
(10) Pub. No.: US 2015/0270679 A1
(43) Pub. Date: Sep. 24, 2015

(54) FABRICATION OF CAPACITIVE DISCHARGE ELECTRODES FOR A RING LASER GYROSCOPE

(71) Applicant: Honeywell International Inc., Morristown, NJ (US)

(72) Inventors: Rodney Harold Thorland, Blaine, MN (US); Douglas Paul Mortenson, Maple Grove, MN (US); Bruce A. Seiber, Arden Hills, MN (US)

(73) Assignee: Honeywell International Inc., Morristown, NJ (US)

(21) Appl. No.: 14/221,718

(22) Filed: Mar. 21, 2014

(51) Int. Cl. H01S 3/097; H01S 3/038

(52) U.S. Cl. CPC H01S 3/09702; H01S 3/038

(57) ABSTRACT

Systems and methods for fabricating capacitive discharge electrodes for a ring laser gyroscope are disclosed. In one example, a laser block for generating a laser in a closed loop path comprises a laser block, wherein an optically closed loop path is formed within the laser block. Additionally, at least two electrodes are formed on the laser block, wherein the at least two electrodes are used in conjunction with a radio frequency power supply to create an electric potential in the laser block which generates at least one laser beam in the closed loop path. The at least two electrodes are manufactured by placing a paste composition on the laser block and securing the paste composition to the laser block. The paste composition also includes a conductive material.

### BACKGROUND

Ring laser gyros (RLGs) are instruments used to measure angular rotation. They include a cavity in which two laser beams travel in counter-propagating (i.e., opposite) directions. The laser beams create an optical interference pattern having characteristics representative of the amount by which the RLG is rotated. The interference pattern is detected and processed to provide the angular rotation measurements.

At least some RLGs use capacitively coupled radio frequency (RF) energy to start and maintain the laser beams within the gyroscope's laser block through the discharge of RF energy. In conventional implementations, electrodes, such as copper strips, are used to transmit RF energy into the laser block of the RLG. The electrodes are secured to the outer surface of the laser block by an adhesive or a mechanical connection. In embodiments where the electrodes are not firmly attached to the laser block and movement of the electrodes relative to the block is possible, problems persist. Moreover, problems with the RLG can occur when there are intervening materials and air gaps between the electrodes and laser block. Conventional implementations, where the electrodes (e.g., copper strips) are secured to the laser block using an adhesive or mechanical connection, often times have intervening gaps and are capable of moving relative to the laser block, regardless of how carefully one secures the electrodes to the laser block.

### SUMMARY

Systems and methods for fabricating capacitive discharge electrodes for a ring laser gyroscope are disclosed. In one example, a laser block for generating a laser in a closed loop path comprises a laser block, wherein an optically closed loop path is formed within the laser block. Additionally, at least two electrodes are formed on the laser block, wherein the at least two electrodes are used in conjunction with a radio frequency power supply to create an electric potential in the laser block which generates at least one laser beam in the closed loop path. The at least two electrodes are manufactured by placing a paste composition on the laser block and securing the paste composition to the laser block. The paste composition also includes a conductive material.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1A is a block diagram of top-down view of an example RLG with capacitive discharge electrodes fabricated on the RLG's laser block in one embodiment described in the present disclosure.

FIG. 1B is a block diagram of a side view of an example RLG with capacitive discharge electrodes fabricated on the RLG's laser block in one embodiment described in the present disclosure.

FIG. 2 is a flow diagram of an example method for fabrication of capacitive discharge electrodes for a RLG in one embodiment described in the present disclosure.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

As mentioned above, conventional implementations of capacitive discharge often times have electrodes which are not firmly attached to the RLG laser block, are capable of moving relative to the laser block and are not in intimate contact with the laser block. The solution proposed by this disclosure is to use a paste composition that includes a conductive material as the electrodes. The paste composition is placed on the laser block and then secured to the laser block to form a reliable connection to the laser block.

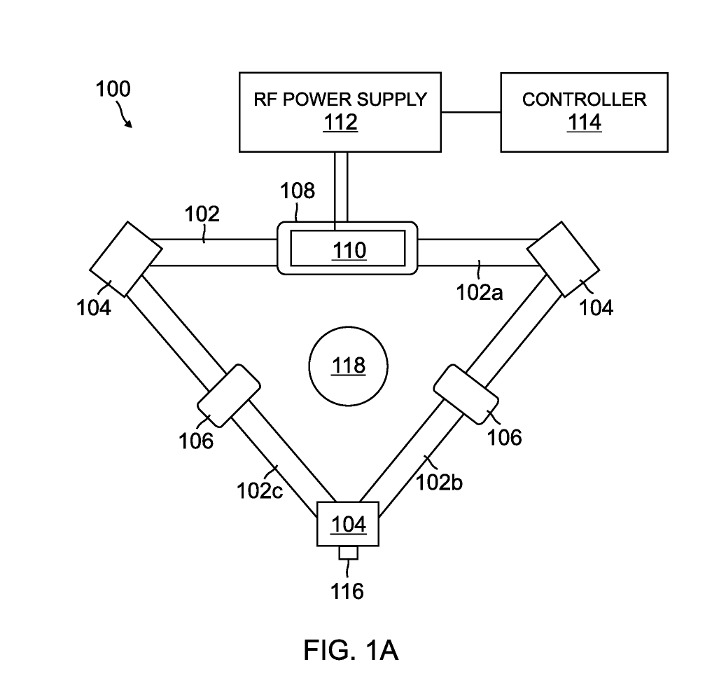

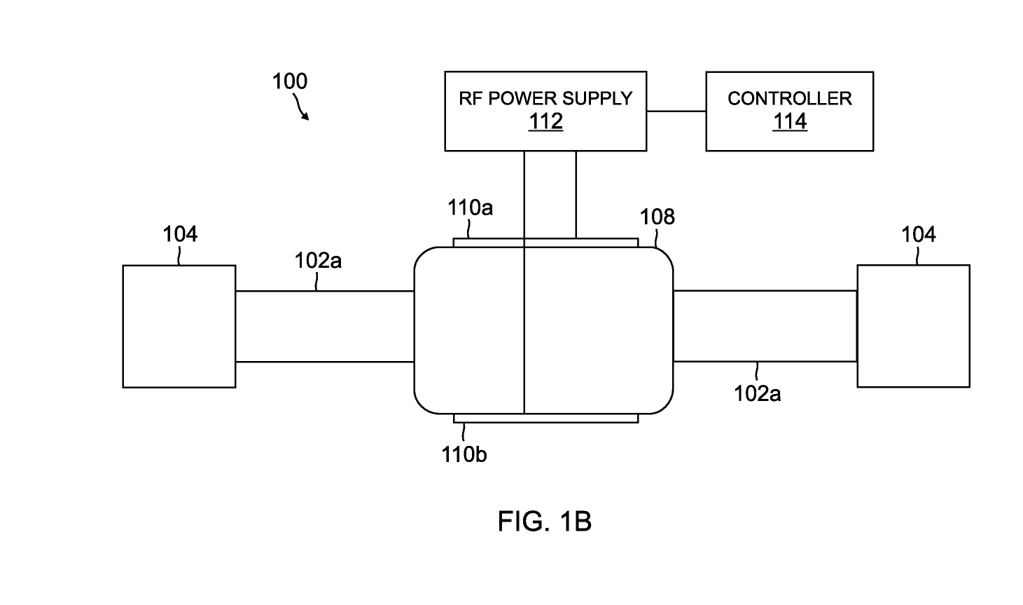

FIG. 1A is a block diagram of an example RLG 100. The RLG 100 includes a laser block 102 comprising a plurality of interconnected passages 102a-102c that form a closed loop path and a laser gas discharge cavity 108. Moreover, the RLG 100 comprises reflective surfaces 104, one or more fill tubes 106, two or more electrodes 110 formed on the laser block 102 that are in proximate location to the laser gas discharge cavity 108, a radio frequency (RF) power supply 112, a controller 114, a sensor 116 for sensing the angular rate of the RLG 100, and a dithering motor 118. The two or more electrodes 110 are manufactured by placing a paste composition on the laser block 102 and securing the paste composition to the laser block 102. As stated above, the two or more electrodes 110 are in proximate location to the laser gas discharge cavity 108. The paste composition includes a conductive material. Moreover, when an RF signal is supplied by the RF power supply 112 to the two or more electrodes 110, formed on the laser block 102, one or more laser beams are created in the laser gas discharge cavity 108 that then travel around the laser block 102 in the interconnected passages 102a-102c.

The controller 114 is electrically connected to the RF power supply 112 and controls the operation of the RF power supply 112 (i.e., the controller 114 can turn the RF power supply 112 on or off). The RF power supply 112 is also electrically connected to the two or more electrodes 110 that are formed on the laser block 102. When the controller 114 instructs the RF power supply to turn on, a high frequency AC discharge (i.e., on the order of hundreds of megahertz) transverse to the optic axis of the RLG 100 is supplied to the two or more electrodes 110, which create two counter-propagating lasers that then travel around the laser block 102 in the interconnected passages 102a-102c. The interference pattern of the counter-propagating lasers is measured by a sensor 116, which is then processed to provide the angular rotation of the RLG 100. In some embodiments, the RF power supply 112 can provide a continuous wave RF signal to the electrodes 112. In other embodiments, the RF power supply 112 can provide a pulsed RF signal to the electrodes 112. Using a pulsed RF signal can sometimes result in less energy use by the RLG 100.

The laser block 102 is formed from a dielectric material having stable temperature expansion characteristics, so that the amount of thermal expansion the laser block 102 experiences during a high temperature application is minimized. Some examples of such materials include glass or glass ceramic. One glass ceramic material that is well-suited for the RLG 100 is marketed under the tradename ZERODUR. The interconnected passages 102a-102c in the laser block 102 form a closed loop path arranged in a polygon shape. Some examples of polygon shapes that the interconnected passages 102a-102c can form are triangles, squares, pentagons, etc. At the intersection of each interconnected passage 102a-102c is a reflective surface 104, such as a mirror, that is positioned and angled so that light from one interconnected passage 102a-102c will be reflected into another interconnected passage 102a-102c. The reflective surfaces 104, therefore, help the interconnected passages 102a-102c form a closed optical loop.

Inside the interconnected passages 102a-102c and the laser gas discharge cavity 108 is a gas, often times called a lasing gas. When the lasing gas inside the laser gas discharge cavity 108 is electrically charged by the two or more electrodes 110, at least one laser is formed that then travels around the interconnected passages 102a-102c. In some embodiments, the lasing gas can be helium neon (HeNe). In some embodiments, the lasing gas can be inserted into the interconnected passages 102a-102c and the laser gas discharge cavity 108 by one or more fill ports 106, as known to one having skill in the art.

As mentioned above, the two or more electrodes 110 are electrically connected to the RF power supply 112 and formed on a laser block 102 proximate to the laser gas discharge cavity 108. The two or more electrodes 110 and the laser gas discharge cavity 108 can be located at various locations on the laser block 102, and FIG. 1A depicts only one example. In other embodiments, the laser gas discharge cavity 108 and the two or more electrodes 110 can be located on interconnected passage 102b or 102c. Regarding the two or more electrodes 110, a first electrode of the two or more electrodes 110 can be located adjacent to a first side of the laser block 102, while a second electrode of the two or more electrodes 110 is then located adjacent to a second side of the laser block 102, such that the first and second sides are on opposing sides of the laser block 102. A clear picture of this is shown in FIG. 1B.

More specifically, FIG. 1B is a block diagram side view of the example RLG 100 shown in FIG. 1A. As described above, the laser block 102 is juxtaposed between two or more electrodes 110a-110b that are in proximate location to the laser gas discharge cavity 108. The electrodes 110a-110b are adjacent to the laser block 102 and on opposing sides of the laser block 102. That is, the first electrode 110a is located on the top of the laser block 102 and a second electrode 110b is located on the bottom of the laser block 102. (The position terms “top” and “bottom” are relative terms and defined with respect to the conventional plane or working surface, wherein “top” is the top surface of the substrate, regardless of the orientation of the substrate.) Therefore, when an RF signal is sent to the electrodes 110a-110b by the RF power supply 112, counter-propagating lasers are created in the laser gas discharge cavity 108, which will then travel around the interconnected passages 102a-102c of the RLG 100. As noted above, this is only one embodiment and the positions of the first electrode 110a and second electrode 110b can be located at different locations on the laser block 102, as long as they are located proximate to the laser gas discharge cavity 108, such that energy can be stored in an electrostatic field between the two or more electrodes 110 and create a laser in the laser gas discharge cavity 108.

As stated above, the two or more electrodes 110 are manufactured by placing a paste composition that includes a conductive material on the laser block 102 and securing the paste composition to the laser block 102. More specifically, the two or more electrodes 110 can be manufactured in the following way. First, the shape and dimensions of the two or more electrodes 110 can be chosen. Once the shape and dimensions of the two or more electrodes 110 are chosen, a form is created so that a composition that fills the form will have the shape and dimensions of the two or more electrodes 110 that were chosen. In one embodiment, the form is separate from the laser block 102. In this embodiment, after the form is created, the form can then be placed on the laser block 102 proximate to the laser gas discharge cavity 108 and then the paste composition is placed within the form on the surface of the laser block 102. In another embodiment, the form can be milled into the laser block 102 proximate to the laser gas discharge cavity 108. After the form is milled into the laser block 102, the paste composition is placed within the form. Under either embodiment, once the paste composition is placed within the form, the paste composition is secured to the laser block 102.

The way the paste composition is secured to the laser block 102 can depend on the material used as the paste composition. In some embodiments, a low temperature glass that includes conductive material can be used as the paste composition. If a low temperature glass that includes a conductive material is used as the paste composition, the paste composition can be hardened and secured to the laser block 102 by heating the low temperature glass. In some embodiments, this is done using an oven-based firing process, as known to one having skill in the art. The low temperature glass can be selected based on its temperature characteristics, in some embodiments. For example, a glass that has a melting point greater than 300 degrees Celsius and less than 550 degrees Celsius can be chosen. One example material of a low temperature glass is DUPONT 7713. After the low temperature glass is heated so that it hardens and is secured to the laser block 102, a RF power supply 112 can be coupled to the electrodes 110 in order to be used in conjunction with the two or more electrodes 110 to create an electric potential in the laser gas discharge cavity 108. The electric potential can then generate at least one laser beam in the laser block 102 that will travel around the interconnected passage 102a-102c.

In other embodiments, an epoxy can be used as the paste composition. If an epoxy that includes conductive material is used as the paste composition, the paste composition can be hardened and secured to the laser block 102 by curing the epoxy. In some embodiments, the epoxy is cured at room temperature. In other embodiments, the epoxy can be cured at a temperature greater than room temperature, e.g., at 150 degrees Celsius or greater. An example of an epoxy that can be used is DUPONT 5064. Similar to above, after the epoxy is allowed to cure and it is secured to the laser block 102, a RF power supply 112 can be coupled to the electrodes 110 in order to be used in conjunction with the two or more electrodes 110 to create an electric potential in the laser gas discharge cavity 108. The electric potential can then generate at least one laser beam in the laser block 102 that will travel around the interconnected passage 102a-102c.

As stated above, the two or more electrodes 110 can be of different shapes. The shapes of the two or more electrodes 110 are chosen in order to effectively couple oscillating electric field energy into the laser block 102 and into the laser gas discharge cavity 108. In some embodiments, the two or more electrodes 110 can be a rectangular shape. In some embodiments, the two or more electrodes 110 can have an elliptical shape. Moreover, the paste composition includes a conductive material. Some examples of conductive material that can be used are silver, gold, copper, graphite and the like.

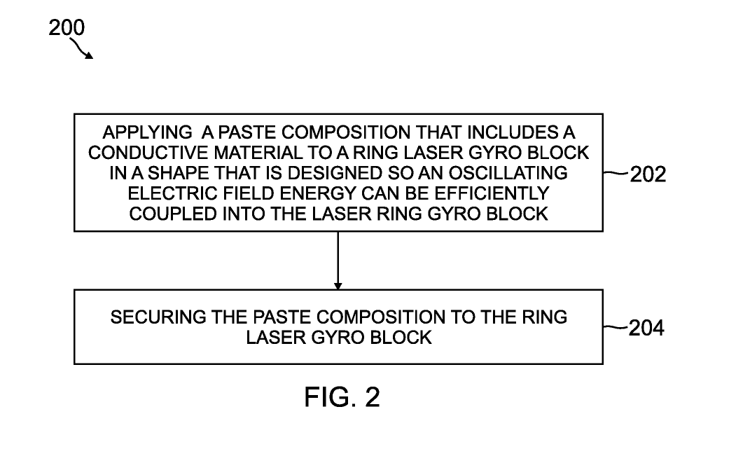

FIG. 2 is a flow diagram of an example method 200 for fabrication of capacitive discharge electrodes for a RLG. The method 200 comprises applying a paste composition that includes a conductive material to an RLG block in a shape that is designed so an oscillating electric field energy can be efficiently coupled into the RLG block (block 202). Further, method 200 includes securing the paste composition to the RLG block (block 204). In some embodiments, securing the paste composition to the RLG block may include heating the paste composition. Heating the paste composition may be done in an oven-based firing process, as known to one having skill in the art. In some embodiments, if the paste composition is an epoxy that includes a conductive material, securing the paste composition to the laser gyro block may include curing the paste composition. In some embodiments, method 200 can also include attaching electrical leads to the paste composition by soldering after the paste composition has been heated. In addition, in some embodiments, the mirrors and fill tubes can be added to the RLG after the paste composition has been heated.

Regarding the RLG, in some embodiments, the RLG can have some or all of the characteristics discussed above in relation to FIGS. 1A and 1B. Moreover, in some embodiments, the paste composition in method 200 can be any of the paste compositions discussed above. Specifically, the paste composition can be a low temperature glass that includes a conductive material or an epoxy that includes a conductive material. Further, the shape of the electrodes in method 200 can be any of the shapes discussed above and the conductive material can be any of the conductive materials discussed above. In particular, in some embodiments, the shape of the electrodes can be rectangular, elliptical, etc. And, in some embodiments, the conductive material in the paste composition can be silver, gold, carbon and the like.

### EXAMPLE EMBODIMENTS

Example 1 includes a laser block for generating a laser in a closed loop path comprising: a laser block, wherein an optically closed loop path is formed within the laser block; and at least two electrodes formed on the laser block, wherein the at least two electrodes are used in conjunction with a radio frequency power supply to create an electric potential in the laser block which generates at least one laser beam in the closed loop path, wherein the at least two electrodes are manufactured by placing a paste composition on the laser block and securing the paste composition to the laser block, and wherein the paste composition includes a conductive material.

Example 2 includes the laser block for generating a laser in a closed loop path of Example 1, wherein the paste composition is an epoxy that includes a conductive material.

Example 3 includes the laser block for generating a laser in a closed loop path of Example 2, wherein securing the paste composition to the laser block includes curing the epoxy.

Example 4 includes the laser block for generating a laser in a closed loop path of any of Examples 1-3, wherein the paste composition is a low temperature glass that includes a conductive material.

Example 5 includes the laser block for generating a laser in a closed loop path of Example 4, wherein securing the paste composition to the laser block includes heating the low temperature glass.

Example 6 includes the laser block for generating a laser in a closed loop path of any of Examples 1-5, wherein the conductive material included in the paste composition is at least one of the following: silver, graphite or gold.

Example 7 includes the laser block for generating a laser in a closed loop path of any of Examples 1-6, wherein the at least two electrodes have a rectangular shape.

Example 8 includes the laser block for generating a laser in a closed loop path of any of Examples 1-7, wherein the at least two electrodes have an elliptical shape.

Example 9 includes the laser block for generating a laser in a closed loop path of any of Examples 1-8, wherein the laser block is comprised of a dielectric material.

Example 10 includes a method of constructing electrodes for a ring laser gyro, the method comprising: applying a paste composition that includes a conductive material to a ring laser gyro block in a shape that is designed so an oscillating electric field energy can be efficiently coupled into the ring laser gyro block; and securing the paste composition to the ring laser gyro block.

Example 11 includes the method of Example 10, wherein the paste composition is a low temperature glass that includes a conductive material.

Example 12 includes the method of Example 11, wherein securing the paste composition to the ring laser gyro block includes heating the low temperature glass.

Example 13 includes the method of Example 12, wherein the paste composition is heated in an oven-based firing process.

Example 14 includes the method of any of Examples 10-13, wherein the paste composition is an epoxy that includes a conductive material.

Example 15 includes the method of Example 14, wherein securing the paste composition to the ring laser gyro block includes curing the epoxy.

Example 16 includes the method of any of Examples 10-15, wherein applying the paste composition to the ring laser gyro includes placing a form on the ring laser gyro block and placing the paste composition within the form.

Example 17 includes the method of any of Examples 10-16, wherein applying the paste composition to the ring laser gyro includes milling out a portion of the ring laser gyro block and then placing the paste composition within the milled out portion of the ring laser gyro block.

Example 18 includes the method of any of Examples 10-17, further comprising attaching electrical leads to the paste composition after the paste composition has been heated.

Example 19 includes the method of any of Examples 10-18, wherein the conductive material included in the paste composition is at least one of the following: silver, graphite or gold.

Example 20 includes a laser block for generating a laser in a closed loop path comprising: a laser block having a closed loop path formed within the laser block, wherein the closed loop path contains a gas that creates a laser within the closed loop path when an electrical potential is applied to the gas; and at least two electrodes which when used in conjunction with a radio frequency power supply create an electric potential in the laser block, wherein the at least two electrodes are manufactured by placing a paste composition on the laser block and securing the paste composition to the laser block, and wherein the paste composition includes a conductive material.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A laser block for generating a laser in a closed loop path comprising:
a laser block, wherein an optically closed loop path is formed within the laser block; and
at least two electrodes formed on the laser block,
wherein the at least two electrodes are used in conjunction with a radio frequency power supply to create an electric potential in the laser block which generates at least one laser beam in the closed loop path,
wherein the at least two electrodes are manufactured by placing a paste composition on the laser block and securing the paste composition to the laser block, and
wherein the paste composition includes a conductive material.

2. The laser block for generating a laser in a closed loop path of claim 1, wherein the paste composition is an epoxy that includes a conductive material.

3. The laser block for generating a laser in a closed loop path of claim 2, wherein securing the paste composition to the laser block includes curing the epoxy.

4. The laser block for generating a laser in a closed loop path of claim 1, wherein the paste composition is a low temperature glass that includes a conductive material.

5. The laser block for generating a laser in a closed loop path of claim 4, wherein securing the paste composition to the laser block includes heating the low temperature glass.

6. The laser block for generating a laser in a closed loop path of claim 1, wherein the conductive material included in the paste composition is at least one of the following: silver, graphite or gold.

7. The laser block for generating a laser in a closed loop path of claim 1, wherein the at least two electrodes have a rectangular shape.

8. The laser block for generating a laser in a closed loop path of claim 1, wherein the at least two electrodes have an elliptical shape.

9. The laser block for generating a laser in a closed loop path of claim 1, wherein the laser block is comprised of a dielectric material.

10. A method of constructing electrodes for a ring laser gyro, the method comprising:
applying a paste composition that includes a conductive material to a ring laser gyro block in a shape that is designed so an oscillating electric field energy can be efficiently coupled into the ring laser gyro block; and
securing the paste composition to the ring laser gyro block.

11. The method of claim 10, wherein the paste composition is a low temperature glass that includes a conductive material.

12. The method of claim 11, wherein securing the paste composition to the ring laser gyro block includes heating the low temperature glass.

13. The method of claim 12, wherein the paste composition is heated in an oven-based firing process.

14. The method of claim 10, wherein the paste composition is an epoxy that includes a conductive material.

15. The method of claim 14, wherein securing the paste composition to the ring laser gyro block includes curing the epoxy.

16. The method of claim 10, wherein applying the paste composition to the ring laser gyro includes placing a form on the ring laser gyro block and placing the paste composition within the form.

17. The method of claim 10, wherein applying the paste composition to the ring laser gyro includes milling out a portion of the ring laser gyro block and then placing the paste composition within the milled out portion of the ring laser gyro block.

18. The method of claim 10, further comprising attaching electrical leads to the paste composition after the paste composition has been heated.

19. The method of claim 10, wherein the conductive material included in the paste composition is at least one of the following: silver, graphite or gold.

20. A laser block for generating a laser in a closed loop path comprising:
a laser block having a closed loop path formed within the laser block, wherein the closed loop path contains a gas that creates a laser within the closed loop path when an electrical potential is applied to the gas; and
at least two electrodes which when used in conjunction with a radio frequency power supply create an electric potential in the laser block,
wherein the at least two electrodes are manufactured by placing a paste composition on the laser block and securing the paste composition to the laser block, and
wherein the paste composition includes a conductive material.
